(19) United States
(12) Patent Application Publication
(10) Pub. No.: US 2024/0420074 A1
(43) Pub. Date: Dec. 19, 2024

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventor: Yoshihisa Honda, Tokyo (JP)

(73) Assignee: NEC Corporation, Minato-ku, Tokyo (JP)

(21) Appl. No.: 18/701,285

(22) PCT Filed: Nov. 9, 2021
(86) PCT No.: PCT/JP2021/041093

§ 371 Date: Apr. 15, 2024

(51) Int. Cl. G06Q 10/0835; G06Q 30/0235

(52) U.S. Cl. CPC G06Q 10/08355; G06Q 30/0235

(57) ABSTRACT

In an information processing device, a delivery address acquisition means acquires a delivery address where a package of a customer is to be delivered. A delivery condition extraction means extracts delivery conditions which increase a delivery density representing a delivery efficiency of packages including the package of the customer based on a default delivery route already determined for packages other than the package of the customer and the delivery address.

### TECHNICAL FIELD

The present disclosure relates to improving of delivery efficiency.

### BACKGROUND ART

With regard to improving delivery efficiency for packages, a “Last One Mile Problem” is well known. The Last One Mile means a last segment from a final base to an end user in logistics, and the last one mile problem refers to a problem of how to improve efficiency of delivery in this segment.

Patent Document 1 and Patent Document 2 disclose techniques for addressing the last one mile problem. Specifically. Patent Document 1 proposes a delivery system which can reduce a time and effort for a user to receive packages when delivery companies which pick up respective packages from a shipping company are different. Moreover, Patent Document 2 relates to consumables for a printing device, and proposes a system for changing prices of the consumables according to respective delivery conditions.

### PRECEDING TECHNICAL REFERENCES

### Patent Document

Patent Document 1: International Publication Pamphlet No. WO2015/111170
Japanese Laid-open Patent Publication No. 2019-161571

### SUMMARY

### Problem to be Solved by the Invention

Patent Documents 1 and 2 do not consider, as a package to be delivered, a perishable item which deteriorates over time, a large home appliance and a large furniture which require installation by a supplier, and the like are not assumed. Moreover, Patent Documents 1 and 2 do not consider the overall delivery efficiency.

It is one object of the present disclosure to improve the delivery efficiency of packages.

### Means for Solving the Problem

According to an example aspect of the present disclosure, there is provided an information processing device including:
a delivery address acquisition means configured to acquire a delivery address where a package of a customer is to be delivered; and
a delivery condition extraction means configured to extract delivery conditions which increase a delivery density representing a delivery efficiency of packages including the package of the customer based on a default delivery route already determined for packages other than the package of the customer and the delivery address.

According to another example aspect of the present disclosure, there is provided an information processing method including:
acquiring a delivery address where a package of a customer is to be delivered; and
extracting delivery conditions which increase a delivery density representing a delivery efficiency of packages including the package of the customer based on a default delivery route already determined for packages other than the package of the customer and the delivery address.

According to a further example aspect of the present disclosure, there is provided a recording medium storing a program, the program causing a computer to perform a process including:
acquiring a delivery address where a package of a customer is to be delivered; and
extracting delivery conditions which increase a delivery density representing a delivery efficiency of packages including the package of the customer based on a default delivery route already determined for packages other than the package of the customer and the delivery address.

### Effect of the Invention

According to the present disclosure, it is possible to acquire a new order and reduce a delivery cost by improving delivery efficiency of packages.

### BRIEF DESCRIPTION OF THE DRAWINGS

FIG. 1 is a block diagram illustrating the entire configuration of a delivery system according to first and second example embodiments.

FIG. 2 illustrates an example of a delivery route.

FIG. 3 illustrates an example of delivery date and time selection screen.

FIG. 4 is a block diagram illustrating a hardware configuration of an optimization device.

FIG. 5 is a block diagram illustrating a functional configuration of the optimization device according to a first example embodiment.

FIG. 6 is a flowchart of a delivery route determination process according to the first example embodiment.

FIG. 7 is a block diagram illustrating a functional configuration of an optimization device according to a second example embodiment.

FIG. 8 is a flowchart of a delivery rout determination process according to the second example embodiment.

FIG. 9 illustrates a functional configuration of an information processing device according to a fourth example embodiment.

FIG. 10 is a flowchart of a process by the information processing device according to the fourth example embodiment.

### EXAMPLE EMBODIMENTS

In the following, example embodiments will be described with reference to the accompanying drawings.

### First Example Embodiment

### [Overall Configuration]

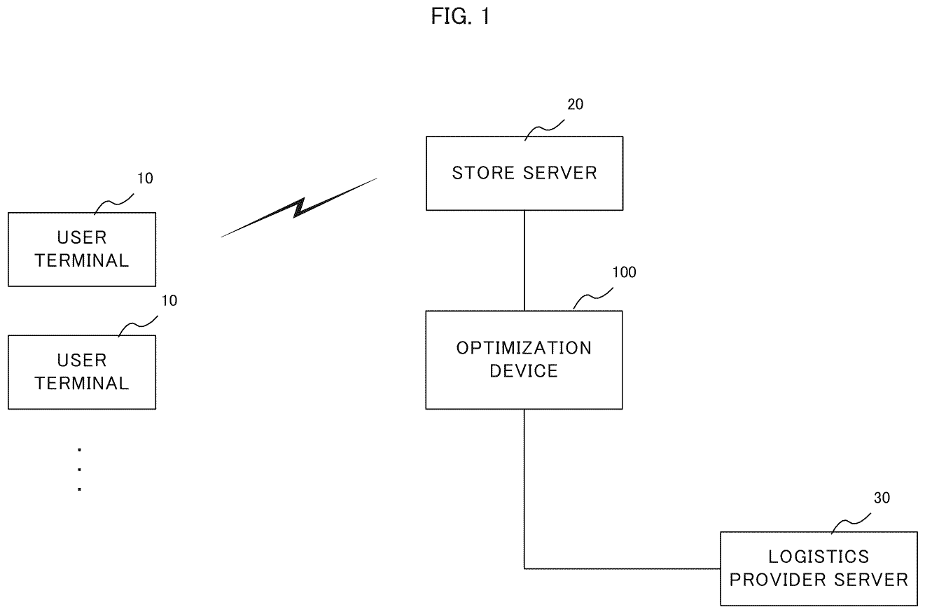

FIG. 1 is a block diagram illustrating an overall configuration of a delivery system according to a first example embodiment. The delivery system includes a user terminal 10, a store server 20, a logistics provider server 30, and an optimization device 100.

The user terminal 10 is a terminal of an end user (hereinafter, referred to as a “customer”) who receives a package, and is, for instance, a PC (Personal Computer), a tablet, a smartphone, or the like. The user terminal 10 communicates with the store server 20 via wired or wireless communications.

The store server 20 is a server for a store such as a supermarket which sells items. The store server 20 is able to communicate with the user terminal 10 and the optimization device 100. The store server 20 operates a service such as a so-called net supermarket, and each customer orders items by connecting the user terminal 10 to a web page of the store. An item ordered by the customer is delivered to a delivery destination such as a home of the customer by a logistics provider. When ordering the item, the customer specifies a date and time (hereinafter referred to as “delivery date and time”) and a delivery address (drop off location) at which the item is to be delivered as the package. The store server 20 transmits the delivery date, the delivery address, and the like which are specified by the customer to the optimization device 100.

The logistics provider server 30 is a server operated by a logistics provider, and is connected to the optimization device 100. The logistics provider server 30 receives the delivery date and time and a delivery route determined by the optimization device 100, and manages the delivery of the package according to the delivery date and time and the delivery route. The item ordered by the net supermarket by the customer operating the user terminal 10 is delivered through the logistics provider according to the delivery date and time and the delivery route determined by the optimization device 100.

The optimization device 100 determines the delivery date and time and the delivery route for a plurality of customers who have ordered through the net supermarket to each customer so that the delivery density indicating the delivery efficiency is increased. As will be described in detail below, the optimization device 100 determines an incentive to the customer in determining the delivery date and time and the delivery route, and creates a delivery date and time selection screen in which candidates of the delivery date and time are associated with the incentive to the customer. The optimization device 100 transmits the determined delivery date and time and the delivery route to the logistics provider server 30.

### [Extract of Delivery Conditions]

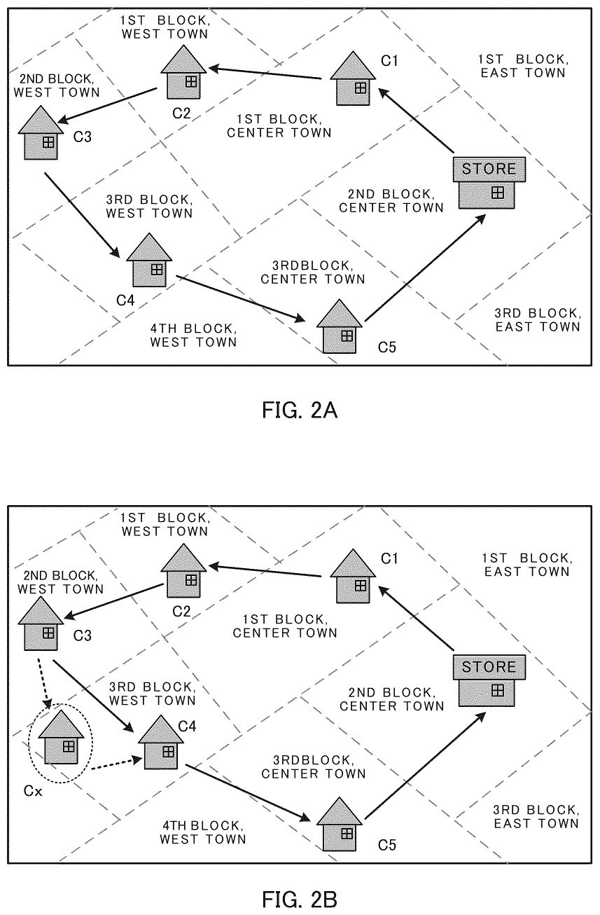

Next, an extraction of delivery conditions will be described in detail. FIG. 2A illustrates an example of the delivery route. The delivery route indicates a starting location, a target location, and a plurality of delivery destinations. Information of the delivery route includes location information specifying the starting location, the target location, and a plurality of delivery addresses, and indicates an order of visiting respective delivery destinations or scheduled times of visiting respective delivery destinations. The delivery route in FIG. 2A is a default delivery route with a delivery date and time “12:00 to 14:00 on Aug. 20, 2021”. This predetermined delivery route departs from the store, visits the delivery destinations (respective homes of customers) C1 to C5 in an order of C1→C2→C3→C4→C5, and returns to the store. Here, the default delivery route refers to a delivery route which has already been determined based on the addresses of the customers as the delivery destinations, for whom orders have been accepted.

Note that in the present example embodiment, a period indicated by one delivery date and time is set as a two-hour unit, but the present disclosure is not limited thereto, and any length for the period indicated by the delivery date and time can be set. In addition, in response to receiving an order is received from each customer, the optimization device 100 determines the delivery route based on the delivery date and time and the delivery address of each customer, and stores the delivery route as the default delivery route in association with the delivery date and time.

When receiving a new order, the optimization device 100 calculates the delivery density for a case of incorporating a new delivery address at each delivery date and time based on the new delivery address received from the store server 20 and the default delivery route. The delivery density indicates a number of deliveries at a given time or region, for instance, the number of deliveries per area or the number of deliveries per hour. In the present example embodiment, the delivery density indicates the number of deliveries in the same town. Next, the optimization device 100 extracts each candidate of the delivery date and time in which the delivery density increases in the case of incorporating the new delivery address, from among the delivery dates and times in the two-hour unit, as a delivery condition. The delivery density may be the number of deliveries by a predetermined delivery means. Here, the predetermined delivery means is, for instance, a truck or a bicycle. The delivery density may be, for instance, the number of deliveries within a predetermined time by a single truck.

Specifically, in the default delivery route with the delivery date and time “12:00 to 14:00 on Aug. 20, 2021” depicted in FIG. 2A, a third delivery destination C3 is located at a 2nd block in a west town and a fourth delivery destination C4 is located at a 3rd block in the west town. In a case where the new delivery address is the delivery destination Cx at the 3rd block in the west town depicted in FIG. 2B, when the default delivery route depicted in FIG. 2A is changed to an order of C1→C2→C3→Cx→C4→C5, the number of deliveries in the same town (west town) can be increased from three deliveries to four deliveries without significantly changing the delivery route. In this case, the number of deliveries increased from three deliveries to four deliveries at the delivery date and time “12:00 to 14:00 on Aug. 20, 2021”, resulting in a higher delivery density.

Thus, the optimization device 100 calculates the delivery density when the new delivery address is incorporated at each delivery date based on the new delivery address and the default delivery route, respectively. Then, as the delivery condition, the optimization device 100 extracts each candidate of the delivery date and time such that the number of deliveries at a predetermined time or region increases, that is, the delivery density increases, by incorporating the new delivery address. Specifically, in the present example embodiment, the optimization device 100 considers each candidate of the delivery date and time in which the number of deliveries in the same town (east town) increases among the delivery dates and times in the two-hour unit, as the candidate of the delivery date and time in which the delivery density increases, and extracts the candidate of the delivery date and time as the delivery condition.

Incidentally, in a case where it becomes impossible to deliver the item for which the order has already been accepted within a time specified by the delivery date and time due to the incorporation of the new delivery address, the optimization device 100 does not receive that order of the delivery date and time regardless of the delivery density.

Moreover, in the present example embodiment, for convenience, the date and time when the order has been received from the customer is “9:00 on Aug. 20, 2021”, and the optimization device 100 calculates the delivery density for each delivery date and time on the date of the order. However, the present disclosure is not limited thereto, and any period for calculating the delivery density can be set such as within 24 hours from the order date, within 3 days from the order date, or the like.

### [Decision on Incentive]

The Next, the decision of the incentive will be described in detail, optimization device 100 determines an incentive to the customer for each candidate of the delivery date and time. As the incentive presented to the customer, for instance, discounting of a delivery charge for the package, presenting of a gift item or a coupon, discounting of a price for the item, presenting of points or miles for an environmental contribution such as SDGs (Sustainable Development Goals indicators) or the like may be considered. In the present example embodiment, the incentive presented to the customer is a discount rate on the delivery charge.

Among candidates for the delivery date and time, the optimization device 100 determines the incentive higher for the delivery date and time with a higher delivery density. In the present example embodiment, since the delivery density is the number of deliveries per area (the number of deliveries in the same town), for instance, for the new delivery address that indicates the west town, the incentive is determined higher the higher the number of deliveries in the west town.

For instance, it is assumed that the number of deliveries in the west town in the delivery date and time “12:00 to 14:00 on Aug. 20, 2021” is four, the number of deliveries in the west town in a delivery date and time “14:00 to 16:00 on Aug. 20, 2021” is two, and the number of deliveries in the west town in other delivery dates and times is zero. In this case, the optimization device 100 determines the highest incentive to the customer for the delivery date and time “12:00 to 14:00 on Aug. 20, 2021” with the highest delivery density. Specifically, incentive information “30% discount on delivery charge” for the incentive is determined. In addition, incentive information “20% discount on delivery charge” is determined with respect to the delivery date and time “14:00 to 16:00 on Aug. 20, 2021”.

In the present example embodiment, the optimization device 100 provides the incentive to the customer for all delivery dates and times in which the delivery density increases; however, the present disclosure is not limited thereto, and may provide the incentive only for a predetermined number of delivery dates and times from higher delivery densities.

### [Delivery Date and Time Selection Screen]

The optimization device 100 creates a delivery date and time selection screen in which the delivery date and time is associated with the delivery charge determined based on the incentive information, for each customer. Also, by transmitting the created delivery date and time selection screen to the store server 20, the optimization device 100 outputs the delivery date and time selection screen to the user terminal 10. Here, the delivery date and time selection screen will be described.

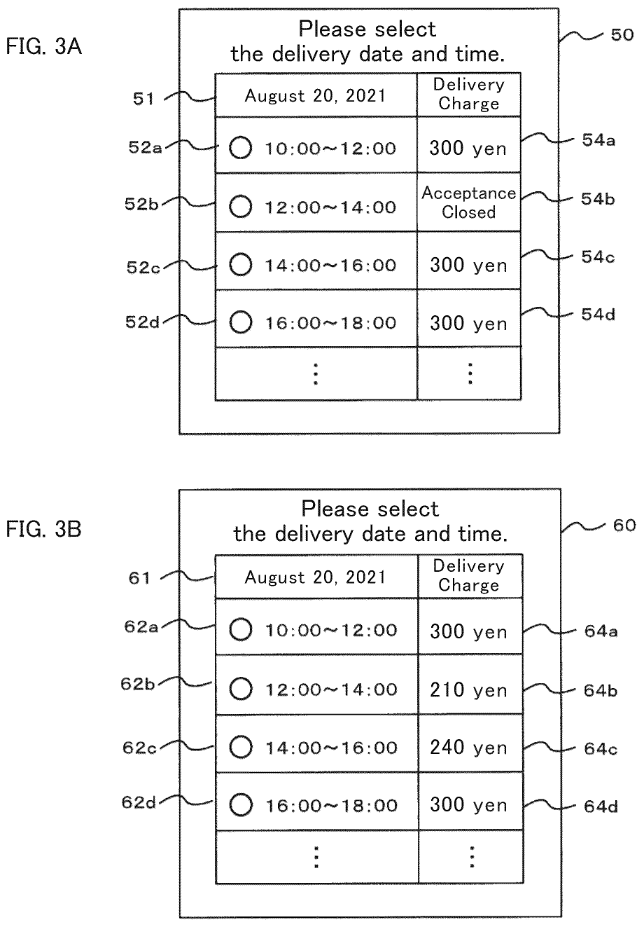

FIG. 3A illustrates an example of the delivery date and time selection screen corresponding to a customer A. In addition, assumed that the delivery address of the customer A is far from the delivery address of another item for which the order has already been accepted, and there is no delivery date and time in which the delivery density increases. As depicted in FIG. 3A, a delivery date and time selection screen 50 corresponding to the customer A includes a message “Please select the delivery date and time” to the customer A, a delivery date item 51 indicating a delivery date “Aug. 20, 2021”, a delivery time item 52 indicating the delivery time in the two-hour unit, and a delivery charge item 54 indicating a delivery charge of each delivery time. The delivery date indicated by the delivery date item 51 and the delivery time item 52 indicate a plurality of candidates for the delivery date and time.

A delivery time item 52a indicates a delivery time “10:00 to 12:00”. A delivery charge item 54a indicates a delivery charge “300 yen” for that delivery time. A delivery time item 52b indicates a delivery time “12:00 to 14:00”, and a delivery charge item 54b indicates “Acceptance Closed” representing that that delivery time cannot be designated for an order. A delivery time item 52c indicates the delivery time “14:00 to 16:00”. A delivery charge item 54c indicates the delivery charge “300 yen” for that delivery time. A delivery time item 52d indicates a delivery time “16:00 to 18:00”. A delivery charge item 54d indicates the delivery charge “300 yen” for that delivery time.

The “Acceptance Closed” of the delivery charge item 54b is displayed in a case where the optimization device 100 determines at a time of calculating the delivery density that it is unable to deliver the item for which the order has already been accepted within a time designated for the delivery date and time if incorporating the delivery address of the customer A for a new order. In the present example embodiment, in a case of “Available”, the delivery charge is displayed in the delivery charge item 54, but the present disclosure is not limited thereto and any display method may be set such as that a message of “Available” and the delivery charge may be separately displayed or the like.

For the delivery address of the customer A, “300 yen” is indicated in which the delivery charge is not discounted for all delivery charge items 54a, 54c, and 54d because there is no delivery date and time when the delivery density increases by incorporating that delivery address.

FIG. 3B illustrates an example of the delivery date and time selection screen corresponding to a customer B. It is assumed that the delivery address of the customer B is the delivery destination Cx of the 3rd block in the west town illustrated in FIG. 2B. In addition, it is assumed that incentive information “30% discount on delivery charge” is determined for the delivery date “12:00 to 14:00 on Aug. 20, 2021” and incentive information “20% discount on delivery charge” are determined for the delivery date and time “14:00 to 16:00 on Aug. 20, 2021”

As illustrated in FIG. 3B, a delivery date and time selection screen 60 corresponding to the customer B includes a message “Please select the delivery date and time” to the customer B, a delivery date item 61 indicating the delivery date “Aug. 20, 2021”, a delivery time item 62 indicating the delivery time in the two-hour unit, and a delivery charge item 64 indicating the delivery charge of each delivery time. A plurality of candidates of the delivery date and time are indicated by the delivery date indicated by the delivery date item 61, and the delivery time item 62.

A delivery time item 62a indicates the delivery time “10:00 to 12:00”, and a delivery charge item 64a indicates the delivery charge “300 yen” for that delivery time. A delivery time item 62b indicates the delivery time “12:00 to 14:00”, and a delivery charge item 64b indicates a delivery charge “210 yen” for that delivery time based on incentive information “30% discount on delivery charge”. A delivery time item 62c indicates the delivery time “14:00 to 16:00”, and a delivery charge item 64c indicates a delivery charge “240 yen” for that delivery time based on incentive information “20% discount on delivery charge”. A delivery time item 62d indicates the delivery time “16:00 to 18:00”, and a delivery charge item 64d indicates the delivery charge “300 yen” for that delivery time.

The user terminal 10 displays the delivery date and time selection screen created by the optimization device 100 through the store server 20. The customer confirms the delivery date and time and the delivery charge on the delivery date and time selection screen, and selects the delivery date and time desired to have the item delivered. The delivery date and time selected by the customer is transmitted from the store server 20 to the optimization device 100.

In this manner, the delivery date and time selection screen is a screen created for each customer, and selects displaying of the delivery charge and displaying of available or the acceptance closed for each customer. Therefore, even at the same delivery date and time, the delivery charge item 54b of the delivery date selection screen 50 illustrated in FIG. 3A indicates “Acceptance Closed”, but in the delivery charge item 64b of the delivery date selection screen 60 illustrated in FIG. 3B, delivery charge can be accepted at “210 yen” with a 30% discount.

By changing the delivery charge for each customer to display, it is possible to guide the customers to the delivery date and time in which the delivery density is increased. Also, in a case where the delivery density can be increased as a result from guiding the customer, a delivery cost of a company can be reduced. On the other hand, in a case where there are a plurality of available delivery dates and times, the customer has more affordable options due to the incentive such as the delivery charge. Also, by selecting the delivery date and time which increases the delivery density, it is possible for the customer to realize contribution to the earth in terms of CO₂ reduction.

Moreover, in a case where the delivery address possible to deliver with higher delivery density is incorporated by selecting the display of available or the display of acceptance closed for each customer, it is possible to further receive the new order. In other words, instead of closing the acceptance with the number of orders per hour as in the past, it is possible to receive the new order regardless of the number of orders per hour in a case where the delivery is possible.

### [Hardware Configuration]

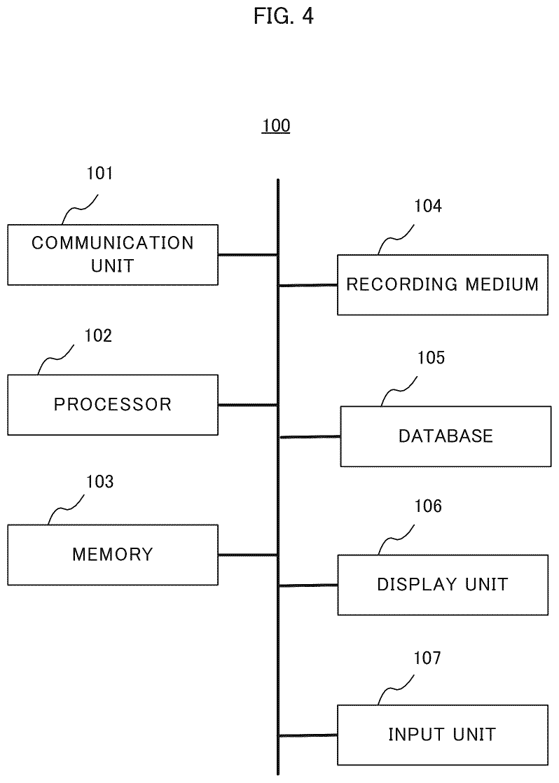

FIG. 4 is a block diagram illustrating a hardware configuration of the optimization device 100. The optimization device 100 includes a communication unit 101, a processor 102, a memory 103, a recording medium 104, a database 105, a display unit 106, and an input unit 107.

The communication unit 101 transmits and receives data to and from the optimization device 100. Specifically, the communication unit 101 receives the delivery address of the customer from the store server 20, the delivery date and time selected by the customer, the item data concerning the item which the customer has ordered, and the like. The communication unit 101 transmits the delivery date and time selection screen created by the optimization device 100 to the store server 20, and transmits the delivery date and time and the delivery route determined by the optimization device 100 to the logistics provider server 30.

The processor 102 is a computer such as a CPU, and controls the entire optimization device 100 by executing programs prepared in advance. The processor 102 may be a GPU (Graphics Processing Unit), or a FPGA (Field-Programmable Gate Array), or the like. Specifically, the processor 102 operates as an optimization agent to perform a delivery route determination process described below.

The memories 103 is formed by a ROM (Read Only Memory, a RAM (Random Access Memory, and the like. The memory 103 stores information concerning the optimization agent used by the optimization device 100. The memory 103 is also used as a working memory during various process operations by the processor 102.

The recording medium 104 is a non-volatile and non-transitory recording medium such as a disk-shaped recording medium, a semiconductor memory, or the like, and is formed to be detachable with respect to the optimization device 100. The recording medium 104 records various programs executed by the processor 102. When the optimization device 100 executes each process, the program recorded in the recording medium 104 is loaded into the memory 103 and executed by the processor 102.

The database (hereinafter, referred to as “DB”) 105 stores the destination address of the customer which the optimization device 100 has received from the store server 20 and item data concerning an item ordered by the customer. The DB 105 also stores the default delivery routes in association with the respective delivery dates and times. In addition, the DB 105 stores data necessary for calculating the delivery density, determining the incentive information, determining a delivery route, and the like, by the optimization device 100. For instance, the DB 105 stores map data, inventory data of items for each store and warehouse, a size or loading capacity of a truck used for delivery, and available information of each driver.

The display unit 106 is, for instance, a liquid crystal display device, and displays various information to an operator. The input unit 107 may be, for instance, a keyboard, a mouse, or the like, and is used by an operator in performing various instructions and inputs. Note that the optimization device 100 may not include the display unit 106 and the input unit 107.

### [Function Configuration]

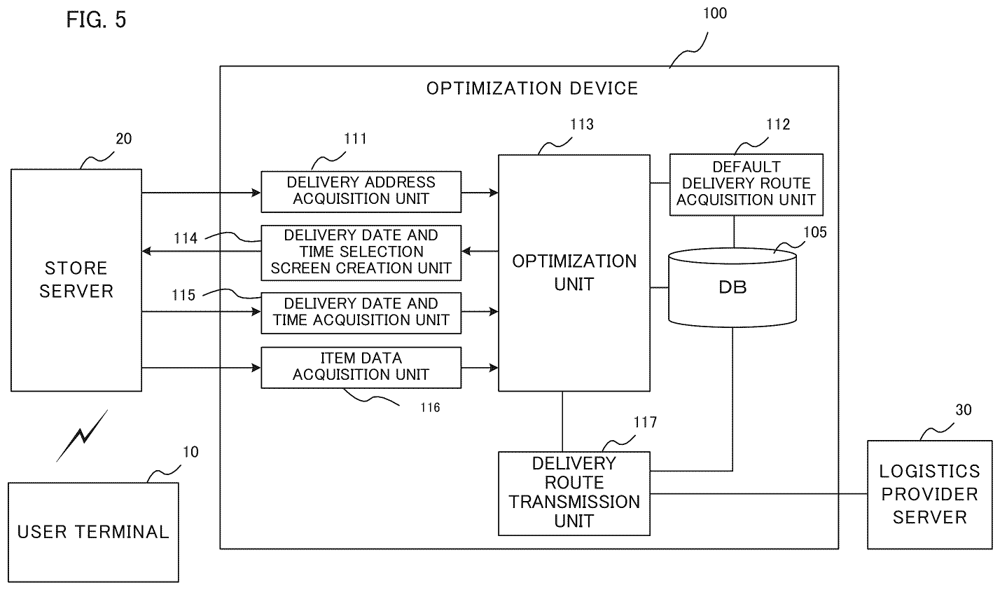

FIG. 5 is a block diagram illustrating a functional configuration of the optimization device 100. The optimization device 100 functionally includes a delivery address acquisition unit 111, a default delivery route acquisition unit 112, an optimization unit 113, a delivery date and time selection screen creation unit 114, a delivery date and time acquisition unit 115, an item data acquisition unit 116, and a delivery route transmission unit 117. The default delivery route acquisition unit 112, the optimization unit 113, and the delivery route transmission unit 117 are connected to the DB 105 described above.

The delivery address acquisition unit 111 receives the delivery address of each customer from the store server 20, and outputs the received delivery address to the optimization unit 113. The delivery address is specified when the customer connects to a web page of the store to order an item using the user terminal 10. The optimization unit 113 stores the delivery address of each customer acquired from the store server 20 in the DB 105. Accordingly, delivery addresses of a large number of customers in the DB 105 are accumulated.

Specifically, the delivery address of the customer may be directly input when the customer connects to the web page of the store using the user terminal 10, or the customer conducts a customer registration or the like with respect to the store in advance and the delivery address is stored in the DB 105 and the delivery address of the customer may be acquired from the DB 105 upon inputting of a login ID or the like by the customer who has connected to the web page of the store using the user terminal 10.

The default delivery route acquisition unit 112 acquires, from DB105, a default delivery route associated with respective delivery date and time on the day of the order, and outputs it to the optimization unit 113.

The optimization unit 113 extracts the candidates of the delivery date and time so that the delivery density is increased by delivering the item to the delivery address as the delivery conditions based on the delivery address acquired by the delivery address acquisition unit 111 and the default delivery route corresponding to each delivery date and time acquired by the default delivery route acquisition unit 112, and outputs the candidates to the delivery date and time selection screen creation unit 114. Moreover, the optimization unit 113 determines the incentive information for the customer based on the extracted candidates of the delivery date and time, and outputs the determined incentive information to the delivery date and time selection screen creation unit 114. Specifically, the optimization unit 113 operates as the optimization agent. The optimization agent is an agent using an AI (Artificial Intelligence) or the like, extracts the candidates of delivery date and time by calculating the delivery density based on the default delivery route and a new delivery address, and determines the incentive information corresponding to each delivery date and time.

The delivery date and time selection screen creation unit 114 creates the delivery date and time selection screen in which the candidates of the delivery date and time are associated with the incentive information, and transmits the created screen to the store server 20. Specifically, the delivery date and time selection screen creation unit 114 creates the delivery date and time selection screen in which the candidates of the delivery date and time on the day of the order and the delivery charge are associated based on the incentive information. The user terminal 10 receives and displays the delivery date and time selection screen created by the optimization device 100 through the store server 20.

The delivery date and time acquisition unit 115 acquires one delivery date and time selected by the customer on the delivery date and time selection screen, from the store server 20. The delivery date and time acquisition unit 115 determines the acquired delivery date and time as a delivery date and time confirmed for delivering the item to the delivery address of the customer (hereinafter referred to as a “confirmed delivery date and time”), and outputs the confirmed delivery date and time to the optimization unit 113.

The item data acquisition unit 116 receives the item data of the customer from the store server 20, and outputs the received item data to the optimization unit 113. The item data are generated when the customer orders the item at a net supermarket or the like of the store using the user terminal 10, and include an item name and the number of items which the customer ordered. The optimization unit 113 stores the item data of each customer acquired from the store server 20 in the DB 105. Accordingly, the item data regarding the large number of customers are stored in the DB 105.

The delivery route transmission unit 117 determines a new delivery route incorporating the delivery address based on the default delivery route corresponding to the confirmed delivery date and time determined by the delivery date and time acquisition unit 115 and the delivery address. Moreover, the delivery route transmission unit 117 stores the determined delivery route as a new default delivery route corresponding to the confirmed delivery date and time in the DB 105, and transmits the new default delivery route to the logistics provider server 30 with the confirmed delivery date and time and the item data. The logistics provider server 30 performs an arrangement of trucks and drivers, an operations management, and the like based on the received confirmed delivery date and time, the new default delivery route, and the item data. In this manner, the package is delivered by the new default delivery route at the confirmed delivery date and time.

In the configuration described above, the delivery address acquisition unit 111 corresponds to an example of a delivery address acquisition means, and the optimization unit 113 corresponds to examples of a delivery condition extraction means and an incentive determination means.

### [Distribution Route Determination Process]

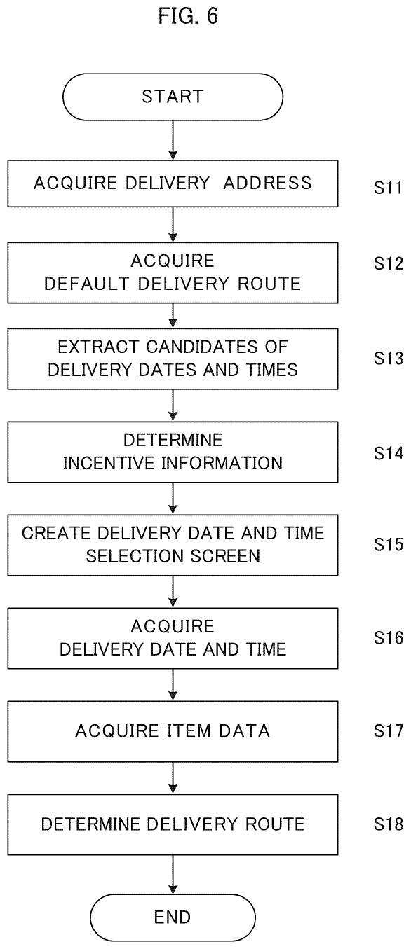

Next, a delivery route determination process by the optimization device 100 will be described. FIG. 6 illustrates a flowchart of a delivery route determination process in the first example embodiment. This process is realized by the processor 102 depicted in FIG. 4 executing a program prepared in advance and operating as each element depicted in FIG. 5.

When connecting the user terminal 10 to the web page of the store and ordering the item, the customer first designates the delivery address. The store server 20 transmits the delivery address specified by the customer to the optimization device 100. The optimization unit 113 acquires the delivery address of the customer from the store server 20 through the delivery address acquisition unit 111 (step S11). Moreover, the optimization unit 113 acquires the default delivery route corresponding to the delivery date and time on the day of the order from the DB 105 through the default delivery route acquisition unit 112 (step S12). Next, the optimization unit 113 extracts the candidates of the delivery date and time so that the delivery density is increased due to delivering of the item to the delivery address based on the delivery address and the default delivery route corresponding to each delivery date and time as the delivery condition (step S13). Furthermore, the optimization unit 113 determines the incentive information for the customer based on the extracted candidates of the delivery date and time (step S14).

The delivery date and time selection screen creation unit 114 creates the delivery date and time selection screen in which the candidates of the delivery dates and times are associated respectively with the delivery charges based on the incentive information, and transmits the created delivery date and time selection screen to the store server 20 (step S15). The user terminal 10 receives and displays the delivery date and time selection screen created by the optimization device 100 through the store server 20. The customer selects the delivery date and time desired to deliver the item using the delivery date and time selection screen. The store server 20 transmits the delivery date and time selected by the customer on the delivery date and time selection screen to the optimization device 100. The delivery date and time acquisition unit 115 acquires the delivery date and time selected by the customer, and determines the confirmed delivery date and time (step S16).

When the customer selects the delivery date and time using the delivery date and time selection screen, the customer continues to select another item on the web page of the store. In response to a completion of the selection of the product by the customer, the store server 20 transmits the item data to the optimization device 100. The optimization unit 113 via the item data acquisition unit 116 receives the item data of the customer from the store server 20 (step S17).

The delivery route transmission unit 117 determines the delivery route incorporating the delivery address based on the default delivery route corresponding to the confirmed delivery date and time and the delivery address, and sets the determined delivery route as a new default delivery route (step S18). After that, the process is terminated.

As described above, in a case of receiving a new order, it is possible for the optimization device 100 according to the present example embodiment to guide the customer to the delivery date and time so that the delivery density is increased by giving the incentive, and thus to improve the delivery efficiency. Therefore, it is possible to reduce a delivery cost. Moreover, by selecting the displaying of the delivery charge or the displaying of available or acceptance closed for each customer, it is possible to acquire the new order on the delivery date and time which was conventionally set as the acceptance closed, and to increase the sales. In other words, it is possible to acquire the new order and to reduce the delivery cost. Moreover, the delivery system of the present example embodiment, since the customer can receive directly, it is possible to apply to a perishable item which deteriorates over time, a large home appliance and a large furniture which require installation by a supplier, and the like as items.

Note that the present example embodiment, the AI is used for calculating the delivery density and determining the incentive information; however, the present disclosure is not limited thereto, and the delivery density may be calculated by a process capable of performing in a short time without using the AI. According to this manner, after the customer specifies the delivery address, the optimization unit 113 can output the delivery date and time selection screen without making the customer wait.

### Second Example Embodiment

Next, a second example embodiment of the present disclosure will be described.

When acquiring the delivery address from the store server 20, the optimization device 100 according to the first example embodiment immediately calculates the delivery density, and creates and outputs the delivery date and time selection screen. On the other hand, an optimization device 100x according to the second example embodiment acquires desired delivery conditions of the customer in advance together with the delivery address from the store server 20. Next, the optimization device 100x calculates the delivery density while the customer selects the item (from acquiring of the desired delivery conditions to acquiring of the item data), and determines the confirmed delivery date and time which meets the desired delivery conditions.

Also, the desired delivery conditions include a date and time at which the customer can receive the item at the delivery address (hereinafter also referred to as a “receivable date and time”), and the optimization device 100x calculates only the delivery density for each delivery date and time in a period indicated by the receivable date and time. Therefore, the optimization device 100x determines the confirmed delivery date and time based on the delivery density, among the delivery dates and times in the period indicated by the receivable date and time.

Since the overall configuration, the extraction of the delivery condition, the determination of the incentive, the delivery date and time selection screen, and the hardware configuration are substantially the same as those of the first example embodiment, the explanations thereof will be omitted for convenience.

### [Functional Configuration]

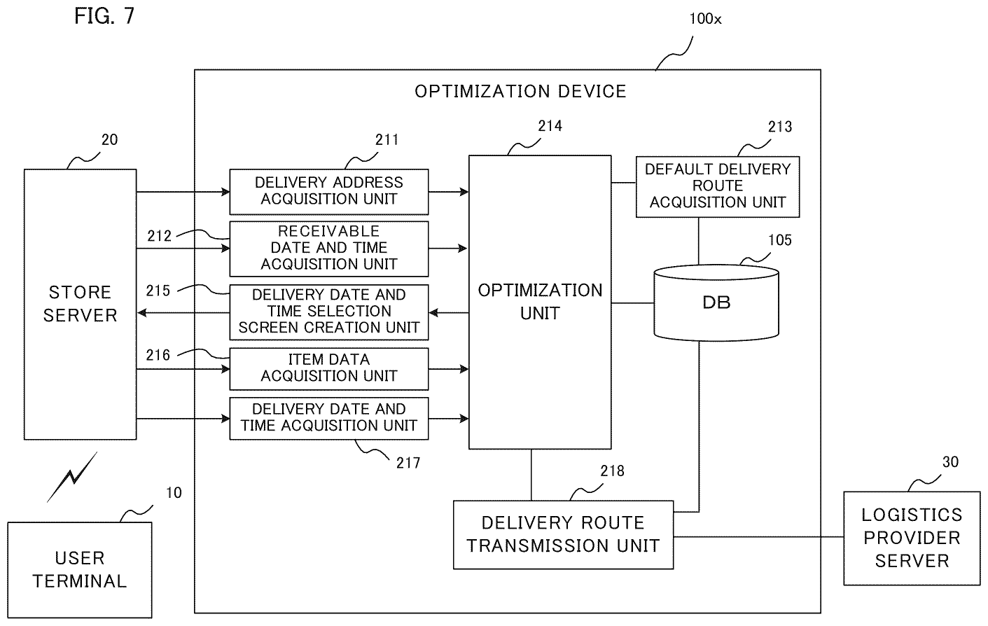

FIG. 7 is a block diagram illustrating a functional configuration of the optimization device 100x. The optimization device 100x functionally includes a delivery address acquisition unit 211, a receivable date and time acquisition unit 212, a default delivery route acquisition unit 213, an optimization unit 214, a delivery date selection screen creation unit 215, an item data acquisition unit 216, a delivery date and time acquisition unit 217, and a delivery route transmission unit 218. The default delivery route acquisition unit 213, the optimization unit 214, and the delivery route transmission unit 218 are connected to the DB 105 described above.

The delivery address acquisition unit 211 receives the delivery address of the customer from the store server 20, and outputs the address to the optimization unit 214. The delivery address is specified when the customer connects to the web page of the store to order the item using the user terminal 10. The optimization unit 214 stores the delivery address of each customer acquired from the store server 20 in the DB 105. In this manner, the plurality of delivery addresses for customers are accumulated in the DB 105.

The receivable date and time acquisition unit 212 receives the receivable date and time of the customer from the store server 20, and outputs to the optimization unit 214. The receivable date and time may be designated by inputting, for instance, “Aug. 20, 2021 10:00 to 18:00” when the customer connects to the web page of the store for ordering the item using the user terminal 10, or by checking a time zone displayed on the web page as in the delivery date and time selection screen.

The default delivery route acquisition unit 213 acquires, from the DB105, the default delivery route which is associated with the delivery date and time in the period indicated by the receivable date and time, and outputs the acquired default delivery route to the optimization unit 214.

The optimization unit 214 extracts, as the delivery conditions, the candidates of the delivery date and time so that the delivery density is increased by delivering the item to the delivery address based on the delivery address acquired by the delivery address acquisition unit 211 and the default delivery route corresponding to each delivery date and time acquired by the default delivery route acquisition unit 213. The optimization unit 214 determines the incentive information for the customer based on the extracted candidates of the delivery date and time. Specifically, the optimization unit 214 operates as the optimization agent, and extracts the candidates of the delivery date and time in the period indicated by the receivable date and time by calculating the delivery density based on the default delivery route and the new delivery address, and determines the incentive information corresponding to each delivery date and time.

The delivery date and time selection screen creation unit 215 creates the delivery date and time selection screen in which the candidates of the delivery date and time in the period indicated by the receivable date and time are associated with the incentive information. Specifically, the delivery date and time selection screen creation unit 215 creates the delivery date and time selection screen in which the candidates of the delivery date and time in the period indicated by the receivable date and time are respectively associated with the delivery charges based on the incentive information. Moreover, when the item data is acquired by the item data acquisition unit 216 which will be described later, the delivery date and time selection screen 215 transmits the created delivery date and time selection screen to the store server 20. The user terminal 10 displays the delivery date and time selection screen via the store server 20.

The item data acquisition unit 216 receives the item data of the customer from the store server 20, and outputs to the optimization unit 214. The item data are generated when the customer orders the item at the net supermarket or the like of the store using the user terminal 10, and includes the item name and the number of items ordered. The optimization unit 214 stores the item data of each customer acquired from the store server 20 in the DB 105. In this manner, the item data regarding the large number of customers are stored in the DB 105.

The delivery date and time acquisition unit 217 acquires the delivery date and time selected by the customer on the delivery date and time selection screen from the store server 20. The delivery date and time acquisition unit 217 determines the acquired delivery date and time as the confirmed delivery date and time, and outputs the confirmed delivery date and time to the optimization unit 214.

The delivery route transmission unit 218 determines a new delivery route incorporating the delivery address based on the default delivery route corresponding to the confirmed delivery date and time determined by the delivery date and time acquisition unit 217, and the delivery address. Moreover, the delivery route transmission unit 218 stores the determined delivery route in the DB 105 as the new default delivery route corresponding to the confirmed delivery date and time, and transmits to the logistics provider server 30 with the confirmed delivery date and time and the item data. The logistics provider server 30 arranges performs an arrangement of trucks and drivers, an operations management, and the like based on the received confirmed delivery date and time, the new default delivery route, and the item data. In this manner, the package is delivered by the new default delivery route at the confirmed delivery date and time.

In the configuration described above, the delivery address acquisition unit 211, the receivable date and time acquisition unit 212, the delivery date selection screen creation unit 215, and the item data acquisition unit 216 correspond to examples of a delivery address acquisition means, a desired delivery condition acquisition means, an output means, and a package information acquisition means, respectively. The optimization unit 214 corresponds to examples of a delivery condition extraction means and an incentive determination means.

### [Distribution Route Determination Process]

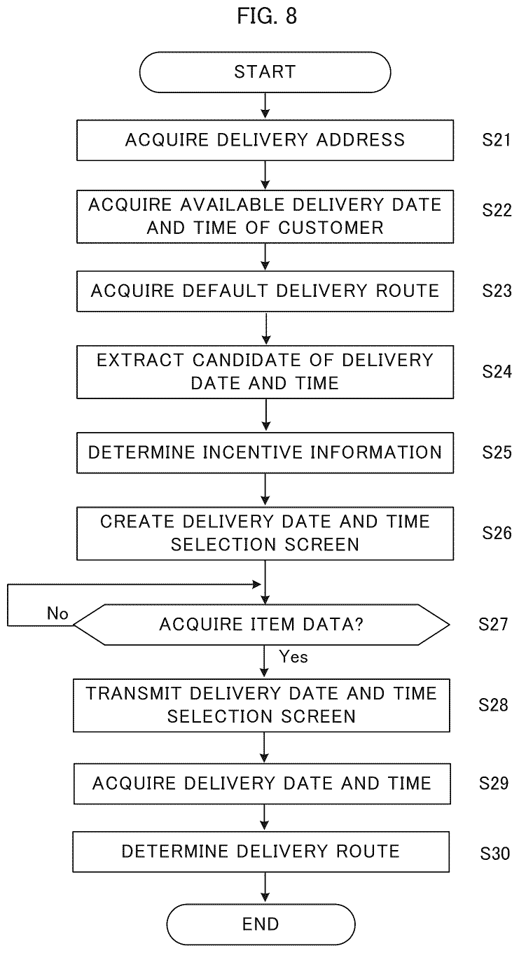

Next, a delivery route determination process by the optimization device 100x will be described. FIG. 8 is a flowchart of the delivery route determination process in the second example embodiment. This process is realized by the processor 102 depicted in FIG. 4 executing a program prepared in advance and operating as each element depicted in FIG. 7.

When the user terminal 10 connects to the web page of the store to order the item, each customer first designates the delivery address and the receivable date and time. The store server 20 transmit the delivery address and the receivable date and time designated by the customer to the optimization device 100x. Thus, the delivery address acquisition unit 211 acquires the delivery address of the customer from the store server 20 (step S21). Moreover, the receivable date and time acquisition unit 212 acquires the receivable date and time of the customer from the store server 20 (step S22).

Next, the default delivery route acquisition unit 213 acquires the default delivery route corresponding to each delivery date and time in the period indicated by the receivable date and time from the DB 105 (step S23). Next, the optimization unit 214 extracts the candidates of the delivery date and time so that the delivery density is increased by delivering the item to the delivery address, based on the delivery address and the default delivery route corresponding to each delivery date and time as the delivery conditions (step S24). Furthermore, the optimization unit 214 determines the incentive information for the customer based on the candidates of the extracted delivery date and time (step S25). Next, the delivery date and time selection screen creation unit 215 creates the delivery date and time selection screen in which the candidates of the delivery date and time in the period indicated by the receivable date and time are respectively associated with the delivery charges based on the incentive information (step S26).

Next, the optimization unit 214 determines whether or not the item data of the customer are acquired from the store server 20 through the item data acquisition unit 216 (step S27). When it is determined that the item data of the customer is not acquired (step S27: No), the delivery date and time selection screen creation unit 215 waits. On the other hand, when it is determined that the item data of the customer have been acquired (step S27: Yes), the delivery date and time selection screen creation unit 215 transmits the created delivery date and time selection screen to the store server 20 (step S28). As described above, the delivery date and time selection screen creation unit 215 transmits the delivery date and time selection screen to the store server 20 at a timing before or after a payment in which the customer completes selecting the item. The user terminal 10 receives and displays the delivery date and time selection screen created by the delivery date and time selection screen creation unit 215 through the store server 20. The customer selects the delivery date and time using the delivery date and time selection screen. The store server 20 then sends the delivery date and time selected by the customer to the optimization device 100x. The delivery date and time acquisition unit 217 acquires the delivery date and time selected by the customer, and determines the delivery date and time to the confirmed delivery date and time (step S29).

The delivery route transmission unit 218 determines the delivery route incorporating the delivery address based on the default delivery route corresponding to the confirmed delivery date and time and the delivery address, and set the determined delivery route as the new default delivery route (step S30). After that, the process is terminated.

As described above, in the present example embodiment, it is possible for the optimization device 100x to calculate the delivery density and create the delivery date and time selection screen during the period from acquiring of the desired delivery conditions to acquiring of the item data, that is, while the customer selects the item. In addition, the optimization device 100x may calculate only the delivery density for each delivery date and time in the period indicated by the receivable date and time specified by the customer, and may create the delivery date and time selection screen corresponding to the period indicated by the receivable date and time. According to this manner, the optimization device 100x can perform complex and high-precision calculations related to the delivery density because there is a time grace.

### Third Example Embodiment

In the second example embodiment, using the delivery date and time selection window created by the optimization device 100x, the customer confirms the delivery date and time and the delivery charge, and selects the desired delivery date and time. However, the present disclosure is not limited thereto, and instead of creating the delivery date and time selection screen, the optimization unit 214 extracts a delivery date and time having the highest delivery density in the period indicated by the receivable date and time, and determines the extracted the delivery date and time as the confirmed delivery date and time. In this case, the optimization unit 214 transmits the confirmed delivery date and time to the store server 20 when the customer ends selecting of the item and the item data are thus acquired. By receiving and displaying the confirmed delivery date and time at the user terminal 10 via the store server 20, the customer can confirm the date and time when the item is to be delivered. In other words, the optimization unit 214 notifies the customer of the confirmed delivery date and time at a timing before or after a payment in which the customer completes selecting the item.

The optimization unit 214 according to the third example embodiment corresponds to an example of a delivery date and time determination means.

### Modifications of the First to Third Example Embodiments

### First Modification

In the first to third example embodiments, as an example in which the delivery density increases, a case where the number of deliveries for each area increases is applied when a new delivery address is incorporated, but the present disclosure is not limited thereto. For instance, the optimization devices 100 and 100x may set a predetermined value in advance and determine that the delivery density increases when the delivery density is higher than the predetermined value.

The optimization devices 100 and 100x may match the delivery address of the item of which the order has already received with the delivery address of the new order, and may determine that the larger a degree of matching, the higher the delivery density. For instance, in a case where the two addresses are the same down to a street number, the optimization devices 100 and 100x determine that the two addresses refer to the same apartment or house, and determine that the delivery date and time when that apartment or home is indicated as the delivery address has the highest delivery density. This is because the new item can be delivered without changing the default delivery route in a case where the same apartment or house is indicated as the delivery address.

The optimization devices 100 and 100x may calculate the delivery density as a score by using a predetermined function where the new delivery address and the default delivery route are arguments. In this case, the optimization devices 100 and 100x determine that the delivery density increases when the score per area or the score per hour increases.

### Second Modification

In the second and third example embodiments, the incentive given to the customer may be greater as the customer designates the receivable date and time to be longer. In this manner, it is possible to guide the customer to make a longer lead time until the receivable date and time, and to thus increase an opportunity for improving the delivery density.

### Fourth Example Embodiment

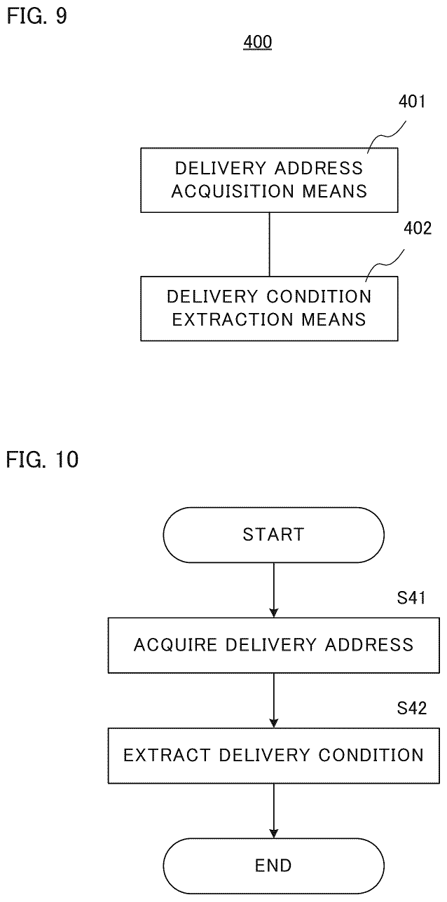

FIG. 9 is a block diagram illustrating a functional configuration of an information processing device 400 according to a fourth example embodiment. The information processing device 400 includes a delivery address acquisition means 401 and a delivery condition extraction means 402.

FIG. 10 is a flowchart of a process performed by the information processing device 400 according to the fourth example embodiment. First, the delivery address acquisition means 401 acquires a delivery address for delivering a package of a customer (step S41). The delivery condition extraction means 402 extracts delivery conditions in which the delivery density representing a delivery efficiency for the package increases based on a default delivery route and delivery addresses already determined for packages other than the package of the customer (step S42).

According to the information processing device 400 of the fourth example embodiment, in a case of receiving the new order, it is possible to reduce the delivery cost by extracting the delivery conditions so as to increase the delivery density.

A part or all of the example embodiments described above may also be described as the following supplementary notes, but not limited thereto.

### (Supplementary Note 1)

An information processing device comprising:
a delivery address acquisition means configured to acquire a delivery address where a package of a customer is to be delivered; and
a delivery condition extraction means configured to extract delivery conditions which increase a delivery density representing a delivery efficiency of packages including the package of the customer based on a default delivery route already determined for packages other than the package of the customer and the delivery address.

### (Supplementary Note 2)

The information processing device according to supplementary note 1, further comprising an incentive determination means configured to determine incentive information concerning an incentive for the customer based on the delivery conditions.

### (Supplementary Note 3)

The information processing device according to supplementary note 2, wherein
the delivery candidates include a delivery date and time; and
the delivery condition extraction means extracts candidates of the delivery date and time so that the delivery density increases, from all dates and times available for the customer.

### (Supplementary Note 4)

The information processing device according to supplementary note 3, wherein
the incentive information includes a discount rate on a delivery charge; and
the incentive determination means determines to increase the discount rate of the delivery charge with respect to the delivery date and time in which the delivery density increases.

### (Supplementary Note 5)

The information processing device according to supplementary note 1, further comprising a desired delivery condition acquisition means configured to acquire desired delivery conditions of the customer,
wherein the delivery condition extraction means extracts the delivery conditions based on the default delivery route, the delivery address, and the desired delivery conditions.

### (Supplementary Note 6)

The information processing device according to supplementary note 5, further comprising an incentive determination means configured to determine incentive information concerning incentive for the customer based on the desired delivery conditions and the delivery conditions.

### (Supplementary Note 7)

The information processing device according to supplementary note 6, wherein
the desired delivery conditions include a receivable date and time of the customer, and the delivery conditions include a delivery date and time, and
the delivery condition extraction means extracts candidates of the delivery date and time when the delivery density increases during the receivable date and time of the customer included in the desired delivery conditions, as the delivery conditions.

### (Supplementary Note 8)

The information processing device according to supplementary note 7, wherein
the incentive information includes a discount rate on a delivery charge, and
the incentive determination means determines to increase the discount rate of the delivery charge with respect to the delivery date and time in which the delivery density increases.

### (Supplementary Note 9)

The information processing device according to supplementary note 8, further comprising an output means configured to output a delivery date and time selection screen including the delivery date and time and the delivery charge calculated based on incentive information.

### (Supplementary Note 10)

The information processing device according to supplementary note 9, further comprising a package information acquisition means configured to acquire package information concerning the package after acquiring the desired delivery condition, wherein
the delivery condition extraction means extracts the delivery condition after acquiring the desired delivery condition, and
the output means outputs the delivery date and time selection screen after acquiring the package information.
   (Supplementary note 11)

The information processing device according to supplementary note 5, wherein
the desired delivery conditions include receivable date and time, and the delivery conditions include a delivery date and time, and
the information processing device further comprises a delivery date and time determination means configured to determine a delivery date and time having the highest delivery density during a receivable date and time of the customer included in the desired delivery condition, as a delivery date and time confirmed to deliver the package to the delivery address, and output the delivery date and time confirmed.

### (Supplementary Note 12)

The information processing device according to supplementary note 11, further comprising an incentive determination means configured to determine incentive information so as to increase an incentive for the customer more as a period indicated by the receivable date and time is longer.

### (Supplementary Note 13)

An information processing method comprising:
acquiring a delivery address where a package of a customer is to be delivered; and
extracting delivery conditions which increase a delivery density representing a delivery efficiency of packages including the package of the customer based on a default delivery route already determined for packages other than the package of the customer and the delivery address.

### (Supplementary Note 14)

A recording medium storing a program, the program causing a computer to perform a process comprising:
acquiring a delivery address where a package of a customer is to be delivered; and
extracting delivery conditions which increase a delivery density representing a delivery efficiency of packages including the package of the customer based on a default delivery route already determined for packages other than the package of the customer and the delivery address.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

### DESCRIPTION OF SYMBOLS

10 User terminal
20 Store server
30 Logistics provider server
100 Optimization device
102 Processor
105 DB
111, 211 Delivery address acquisition unit
112, 212 Default delivery route acquisition unit
113, 214 Optimization unit
114, 215 Delivery date selection screen creation unit
115, 217 Delivery date acquisition unit
116, 216 Item data acquisition unit
117, 218 Delivery route transmission unit
212 Receivable date and time acquisition unit

What is claimed is:

1. An information processing device comprising:
a memory storing instructions; and
one or more processors configured to execute the instructions to:
acquire a delivery address where a package of a customer is to be delivered; and
extract delivery conditions which increase a delivery density representing a delivery efficiency of packages including the package of the customer based on a default delivery route already determined for packages other than the package of the customer and the delivery address.

2. The information processing device according to claim 1, wherein the one or more processors are further configured to determine incentive information concerning an incentive for the customer based on the delivery conditions.

3. The information processing device according to claim 2, wherein
the delivery candidates include a delivery date and time; and
the one or more processors extract candidates of the delivery date and time so that the delivery density increases, from all dates and times available for the customer.

4. The information processing device according to claim 3, wherein
the incentive information includes a discount rate on a delivery charge; and
the one or more processors determine to increase the discount rate of the delivery charge with respect to the delivery date and time in which the delivery density increases.

5. The information processing device according to claim 1, wherein the one or more processors are further configured to acquire desired delivery conditions of the customer,
wherein the one or more processors extract the delivery conditions based on the default delivery route, the delivery address, and the desired delivery conditions.

6. The information processing device according to claim 5, wherein the one or more processors are further configured to determine incentive information concerning incentive for the customer based on the desired delivery conditions and the delivery conditions.

7. The information processing device according to claim 6, wherein
the desired delivery conditions include a receivable date and time of the customer, and the delivery conditions include a delivery date and time, and
the one or more processors extract candidates of the delivery date and time when the delivery density increases during the receivable date and time of the customer included in the desired delivery conditions, as the delivery conditions.

8. The information processing device according to claim 7, wherein
the incentive information includes a discount rate on a delivery charge, and
the one or more processors determine to increase the discount rate of the delivery charge with respect to the delivery date and time in which the delivery density increases.

9. The information processing device according to claim 8, wherein the one or more processors are further configured to output a delivery date and time selection screen including the delivery date and time and the delivery charge calculated based on incentive information.

10. The information processing device according to claim 9, wherein the one or more processors are further configured to acquire package information concerning the package after acquiring the desired delivery condition, wherein
the one or more processors extract the delivery condition after acquiring the desired delivery condition, and
the one or more processors output the delivery date and time selection screen after acquiring the package information.

11. The information processing device according to claim 5, wherein
the desired delivery conditions include receivable date and time, and the delivery conditions include a delivery date and time, and
the one or more processors are further configured to determine a delivery date and time having the highest delivery density during a receivable date and time of the customer included in the desired delivery condition, as a delivery date and time confirmed to deliver the package to the delivery address, and output the delivery date and time confirmed.

12. The information processing device according to claim 11, wherein the one or more processors are further configured to determine incentive information so as to increase an incentive for the customer more as a period indicated by the receivable date and time is longer.

13. An information processing method comprising:
acquiring a delivery address where a package of a customer is to be delivered; and
extracting delivery conditions which increase a delivery density representing a delivery efficiency of packages including the package of the customer based on a default delivery route already determined for packages other than the package of the customer and the delivery address.

14. A non-transitory computer readable recording medium storing a program, the program causing a computer to perform a process comprising:
acquiring a delivery address where a package of a customer is to be delivered; and
extracting delivery conditions which increase a delivery density representing a delivery efficiency of packages including the package of the customer based on a default delivery route already determined for packages other than the package of the customer and the delivery address.
